(19) United States
(12) Patent Application Publication
(10) Pub. No.: US 2026/0141026 A1
(43) Pub. Date: May 21, 2026

(54) Large Bandwidth High Data Rate Signal Processing

(71) Applicants: Anthony V. Bausas, Virginia Beach, VA (US); Leon Crayton Gregg, JR., Portsmouth, VA (US)

(72) Inventors: Anthony V. Bausas, Virginia Beach, VA (US); Leon Crayton Gregg, JR., Portsmouth, VA (US)

(73) Assignee: United States of America, as represented by the Secretary of the Navy, Arlington, VA (US)

(21) Appl. No.: 18/953,235

(22) Filed: Nov. 20, 2024

(51) Int. Cl. G06F 18/21; H04B 17/309

(52) U.S. Cl. CPC G06F 18/21; H04B 17/346

(57) ABSTRACT

A computer-implemented method is provided for compressing a signal. The method includes acquiring the signal; sampling a plurality of values from the signal; assigning to an event each value that exceeds an event threshold, and removing each value in response to equivalence within a tolerance to previous and subsequent adjacent values. Each value is associated with a time stamp and separated from an adjacent value by an interval gap.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to signal processing. In particular, the invention relates to analyzing electronic signals at high data rates and large bandwidth to compress the memory size of signal characteristics.

With the rapid advancement of wide Radio Frequency (RF) bandwidth signal technologies being employed in complex radar emitters in civilian and military applications throughout the world, the requirement to capture very large bandwidth recordings for signal record verification and analysis of emitters has increased significantly. The advancement of recorder architecture and data storage capability has made this possible, however, at the expense of very large data files in the order of Terabytes.

Unfortunately, the development of tools to process and analyze large bandwidth signals of interest (SOI's) has not been able to keep pace with the rapid advancements in regard to the collection of these signals. As a result, the analysis of these signals using traditional methods of analysis and verification of signal recordings require an enormous number of hours for personnel as well as computer processing power and speed required for signal processing.

During the recording process, Intermediate Frequency (IF) analog data are transformed via sampling into digital data called Continuous Digital Intermediate Frequency (CDIF). During this transformation, various techniques to reduce the data size rely primarily on detecting energy above a set level during the recording and extracting only those associated samples into the resulting capture. A couple of examples of these types of files are Burst Detected Intermediate Frequency (BDIF) and Amplitude Detected Intermediate Frequency (ADIF) files. There are significant short-comings associated with both methods due to a reduced capability to ensure 100% SOI capture and limited capability post recording to extract additional feature data.

### SUMMARY

Conventional signal compression yield disadvantages addressed by various exemplary embodiments of the present invention. In particular, various exemplary embodiments provide a computer-implemented method for compressing characteristics of a signal. The method includes acquiring the signal; sampling a plurality of values from the signal; assigning to an event each value that exceeds an event threshold, and removing each value in response to equivalence within a tolerance to previous and subsequent adjacent values. Each value is associated with a time stamp and separated from an adjacent value by an interval gap.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a tabular view of bandwidth and process values;

FIG. 2 is a timeline view of a packetized grouping;

FIG. 3 is a datagram view for different bandwidths;

FIG. 4A is a graphical view of time versus magnitude;

FIG. 4B is a graphical view of frequency versus spectrum;

FIG. 5 is a graphical view of a temporal signal plot with discretization;

FIG. 6 is an array view of data tables and associated plot;

FIG. 7 is a graphical view of interspersed pulse signals; and

FIG. 8 is a flowchart view of an exemplary sample selection process.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, artisans of ordinary skill will readily recognize that devices of a less general purpose nature, such as hardwired devices, may also be used without departing from the scope and spirit of the inventive concepts disclosed herewith. General purpose machines include devices that execute instruction code. A hardwired device may constitute an application specific integrated circuit (ASIC), a field programmable gate array (FPGA), digital signal processor (DSP) or other related component. The disclosure generally employs quantity units with the following abbreviations: time in seconds(s), frequencies in gigahertz (GHz), and memory in bytes (B).

Exemplary embodiments provide technical solutions in development to addresses current and future increases in record data rates anticipated with technology expansion. The key technical challenge involves developing an algorithm that will provide the appropriate noise riding threshold (NRT) independent of record channel input to ensure 100% of SOI capture (above a specified power level)—while minimizing false detections. The NRT is described in U.S. Pat. No. 6,433,730 to Borla (Navy Case 79084). Any processing constraints of the associated Field Programmable Gated Array (FPGA) or Application-Specific Integrated Circuit (ASIC) hardware used to perform the detection and buffer the CDIF data should be analyzed and may potentially limit the efficient application of the algorithm on some platforms.

Exemplary embodiments describe a signal analysis implementation that maps the CDIF recording (time, magnitude, and frequency) to a spectrogram, referred to here as a Spectral Thumbnail, produced in parallel to a standard CDIF recording. The algorithm is performed on the CDIF recording to detect all energy (transient or continuous) above an NRT. From the results of applying the exemplary algorithm; time, magnitude, and bandwidth information are stored in a separate file that is associated and dynamically linked with the CDIF recording. This enables the operator and the analyst to quickly review the contents of a recording using the associated indexing and time stamp information, and only download the portion of the recording that is of interest. The thumbnail is significantly smaller than the original recording and has a variable rate based on the duty cycle of the SOI. Current estimates of file size relative to the CDIF are one to two percent. The original CDIF recording is retained.

The solution is still in the development phase and concurrently being pursued in tandem with Innovative Integration, the manufacturer of key hardware portions of a government-developed digital recorder. Once a satisfactory algorithm has been developed, the solution simulated in MATLAB will be delivered to Combat Direction Systems Activity (CDSA) Dam Neck, who will in turn fully test and make available to interested Defense Department and commercial entities. Efforts are concurrently proceeding with the groups that update analysis software suites so this type for these data can be integrated seamlessly into future products.

One of the primary advantages is the large cost savings distributed across the multiple activities associated with supporting the engineering development and testing, the fleet operators responsible for signal verification during collection, and the analysts that provide the detailed post mission reporting. The efficiencies provided by the Spectral Thumbnail potentially translates into many saved man-hours per mission review. This is also superior from a technical standpoint due to the implementation keeping the original CDIF recording intact, enabling additional and more detailed analysis typically desired by signal analysts.

The approach is unique due to a number of features contained in the methods that produce the resulting thumbnail file. By performing the algorithm real-time in the FPGA/ASIC, indexing of the data from the original CDIF recording is much more efficient and requires minimal read/write operations due to the limited number of samples continuously transformed per iteration. Other methods have performed similar operations upon completion of the CDIF recording which makes this indexing more complex and time-consuming due to the extremely large data array size. This exemplary method also applies unique interpolation techniques that are efficient in maximizing point reduction of transformed data in the frequency, time, and magnitude domains. This will enable the reduction in size expected relative to the CDIF recording.

By using unique and intuitive methods with the exemplary approach to this problem, exemplary embodiments are expected to maximize signal analysis capabilities using the materials and technology that currently exist. The exemplary algorithm also provides a new roadmap that addresses the anticipated growth of SOI bandwidth requirements while moving away from the existing “brute force” (costly high-performance hardware and many man-hours) approach.

A large motivating factor for development of the exemplary solution was to reduce hardware costs required to support satisfactory screening and evaluation of SOI's contained in large bandwidth recordings. These costs directly correlate to increased central processing unit (CPU) performance and speed. This in turn typically translate into additional size and cost requirements for CPU & Memory performance. The solution lowers the threshold, which in turn reduces size, weight, and costs across all activities involved with performing screening and evaluation processes. In addition, the exemplary approach reduces the man-hours and associated costs involved in the process, increasing efficiency and convenience.

The methods utilized in this solution can be applied to any situation in which data are continually collected, but only a small-percentage is ultimately desired for final capture or analysis. Typically, the difficulty in screening the data collected for pertinent information is the problem of identification efficiency, time requirements, and costs. Commercial entities performing “Big Data Analytics” might be interested in the exemplary real-time approach to the problem.

With the rapid advancement of computer architecture and data storage capability, the desire to capture large bandwidth recordings has increased significantly. The advantages afforded performing filtering, frequency conversion, demodulation, etc. on Continuous Digital Intermediate Frequency (CDIF) signals is a primary factor. These rapid advancements unfortunately have not translated accordingly when processing these large bandwidth—high-data rate signals via analysis tools. This burden has significantly increased the number of hours required for signal reporting/screening from the analysis labs due to utilization of the same resources (hardware & personnel) during this process. The solution proposed in this paper will greatly reduce the resources required for successful screening of SOI's at the analysis labs—in addition to providing rapid verification of SOI's recorded while still on mission.

In digital signal processing, one can define the sampling theorem as the overall construct that bridges transition continuous-time signals (analog domain) to discrete time signals (digital domain). This construct encompasses an entire class of mathematical functions relevant to maintaining faithful reproduction of the original analog domain into discrete numeric sequences that describe the original time and magnitude of the analog domain recorded. The primary concern outside of design specifications is strict adherence to the Nyquist-Shannon sampling theorem. Adhering to this theorem inhibits occurrence of aliasing when performing an analog-digital transformation and prevents erroneous signals from appearing when analyzing in the digital domain. The recorders employed primarily use a sub-sample process for analog-digital domain conversion that eliminates the requirement to convert receiver's Intermediate Frequencies (IF) to baseband before digitization.

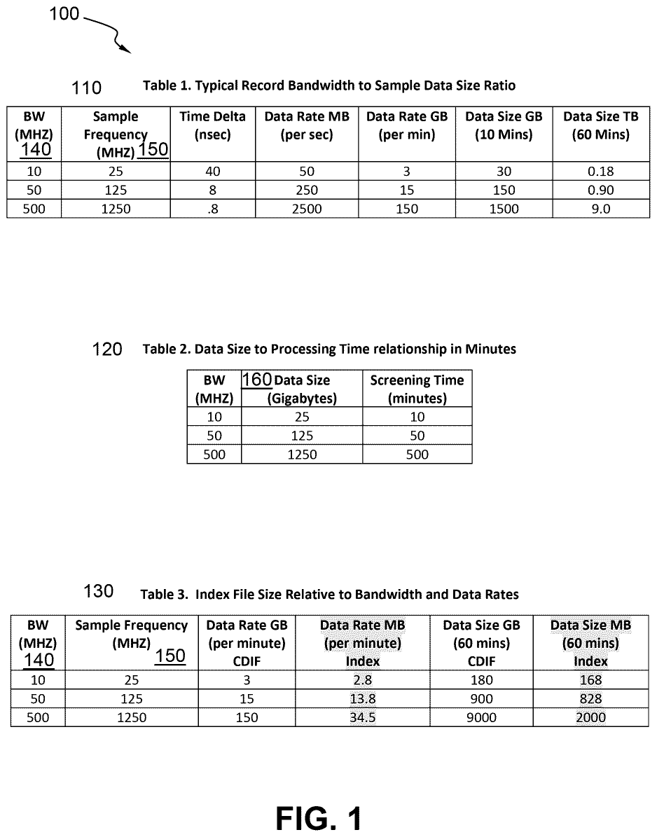

FIG. 1 shows a tabular view 100 of bandwidth and process values. Table 1 lists a set 110 of a typical ratio between bandwidth and sample data size. Table 2 lists a set 120 comparing data size to screening time. Table 3 lists a set 130 of index file size in relation to bandwidth and data rates. Bandwidth 140 (in megahertz) resides in the far left column for all three sets 110, 120 and 130. Sample frequency 150 (also in megahertz) and data size 160 (in gigabytes) share corresponding values for their respective units, with the latter in the second set 120, while the former belong to both first and third sets 110 and 130. Coincidentally, column values for data size 160 correspond by a three-order-of-magnitude factor the values to the sample frequency 150.

Set 110 provides some standard recording bandwidths and their minimum sample frequency (both in megahertz) and required data rates (in bytes per second). If one assumes the time required to screen a single SOI at the analysis laboratory maintains the same relationship for processing, the set 110 reflects the associated increase in man-hours and signal processing time. Sets 110 and 130 compare bandwidth 140 to sample frequency 150. Set 120 compares bandwidth 140 to data size 160.

Unfortunately, this processing relationship for increasingly large bandwidth signals is worse than the simple relationship prescribed in set 120. These signals are typically more complex and exhibit various spreading techniques for range increases and covertness. Additionally, the computer hardware used for processing becomes less effective due to resources available, e.g., CPU calculations, random access memory (RAM), and internal bus speeds. Absent suitable tools developed to expedite analysis/screening of SOI's, and/or hardware specifications, required manpower levels correspondingly increase—the potential exists that very little value can be added to overall signal collection.

This progression has increased the time required for the platform operator to verify that the recording was successful upon completion of the event. The conventional process provides limited upstream monitoring, so successful recording validation must be performed using analysis software resident on the recorder. This transition process has required that operators receive additional training using analysis software to verify successful recording—and increases the time required to perform this operation.

This progression has also increased the time required for screening and reporting mission data in laboratory operations. The conventional process requires the uploading to a “cloud” before they can be shared and distributed to appropriate commands. The time to perform this upload increases significantly with the addition of the large bandwidth, high-data rate recordings produced by the new hardware. This increase can also be realized when analysis and reporting are performed due to the bandwidth constraints placed on the network required to download files required to analyze signal properties. The difficulties encountered when storing and processing large bandwidth signals isn't a new issue, but has been exacerbated with the rapid increase of storage capability and resource bandwidth. There are several methodologies applied that are used to address this issue—but they all have significant shortcomings.

Burst Digital Intermediate Frequency (BDIF): In this application, a DSP is performed to detect all pulse energy residing in the CDIF channel. The associated CDIF data relevant to the time period (pulse width) is then stored with its emitter identification and delta time-of-arrival (DTOA) information. This approach is dependent on the initial pulse detection algorithm used and its probability of intercept (POI) of desired energy. Additionally, because the data saved are non-continuous—analytic tools used to extract additional parametric data typically can't be utilized because they doesn't permit sample integration.

Scan Digital Intermediate Frequency (SDIF): This approach is similar to the algorithm applied to BDIF—but all CDIF contained in the illumination time window is kept. This does permit some integration of samples totaling the time period of the illumination—but again it is limited, being dependent on the POI of the algorithm used to detect pulse and identify illumination time of emitter. All data are lost when stored outside of illumination window determined by the detection algorithm.

Amplitude Detected Intermediate Frequency (ADIF): In this application, an algorithm is performed to detect all energy above the noise riding threshold (NRT). The energy includes pulse and continuous wave (CW). Once the bins that contain energy above a predetermined level are identified, they are extracted and stored in the data recording. All data bins absent of detected energy are discarded—minimizing storage requirements. All data are lost when stored outside of threshold detection level determined by the detection algorithm.

Continuous Detected Intermediate Frequency (CDIF) with a detached file: The exemplary spectrum & event file represents the approach proposed in this disclosure and will be subsequently described in detail. CDIF is similar to the methods applied in ADIF data recording—with two key differences. First, an exemplary algorithm is executed to detect all energy (transient or continuous) above the NRT. Second, CDIF is distinguished from ADIF by its performance conducted separately on a duplicate thread of the complex sampled data.

The first in first out (FIFO) memory in the FPGA or ASIC is used to buffer and perform complex algorithms to characterize frequency spectra and magnitude in the time domain. This creates an index that describes the sampled data in frequency spectra and absolute magnitude linked in the time domain. This index is stored in a separate file associated with the CDIF recording, along with specified event data (illumination times, etc.). All sample data are retained, which enables additional analytics to be performed.

The methodology below references the analog to digital conversion process that is used currently in NSWC Dahlgren's narrowband recorder (called VERITAS). This process can be modified to support storage of an additional detached file linked to the conventional CDIF recordings that contain the indexed data. The level of magnitude detection and frequency resolution desired may be somewhat limited with the existing recorder hardware, the extent of which, if any, will be determined during the development phase. The proof of concept will be performed on the VERITAS recorder and with newer Innovative Integration (VERITAS OEM) cards or hardware that supports a large-bandwidth (500 MHz or greater) application.

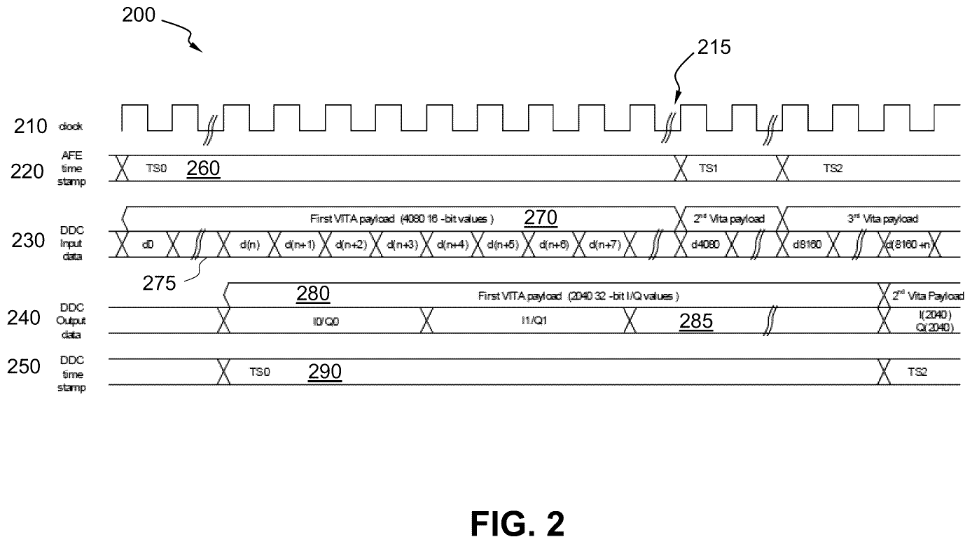

FIG. 2 shows a timeline view 200 of packetized grouping of complex samples. Traces include a clock 210 shown with gaps 215 between the square-wave intervals, an analog front end (AFE) time stamp 220, direct digital control (DDC) input data 230, DDC output data 240 and a DDC time stamp 250. The AFE time stamp (TS) 220 includes numbered TS intervals 260. The DDC input data 240 are packaged in 16-bit VITA payloads 270 corresponding to the TS intervals 260 as bit values 275. The DDC output data 240 are packaged as 32-bit VITA payloads 280 with numbered quartile intervals 285. The DDC time stamp 250 includes numbered TS intervals 290 corresponding to the VITA payloads 280.

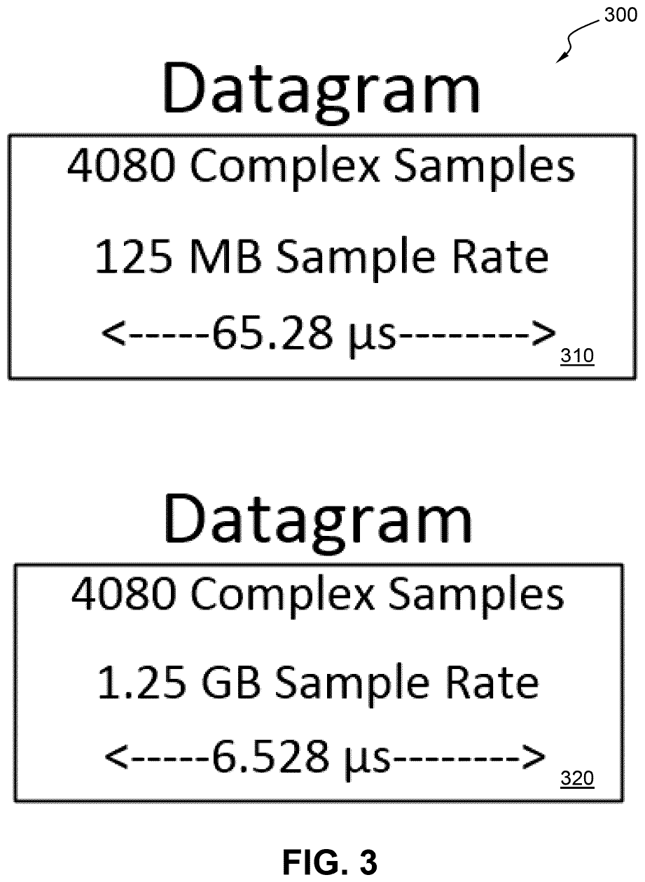

FIG. 3 shows datagram views 300 for a first 50 MHz bandwith datagram 310 and for a second 500 MHz bandwidth datagram 320, both for 4080 complex samples. The first datagram 310 operates on a 125 MB sample rate at 65.28 μs, while the second datagram 320 operates on a 1.25 GB sample rate at 6.528 μs. These datagrams 310 and 320 provide summary information of the analyzed data sets.

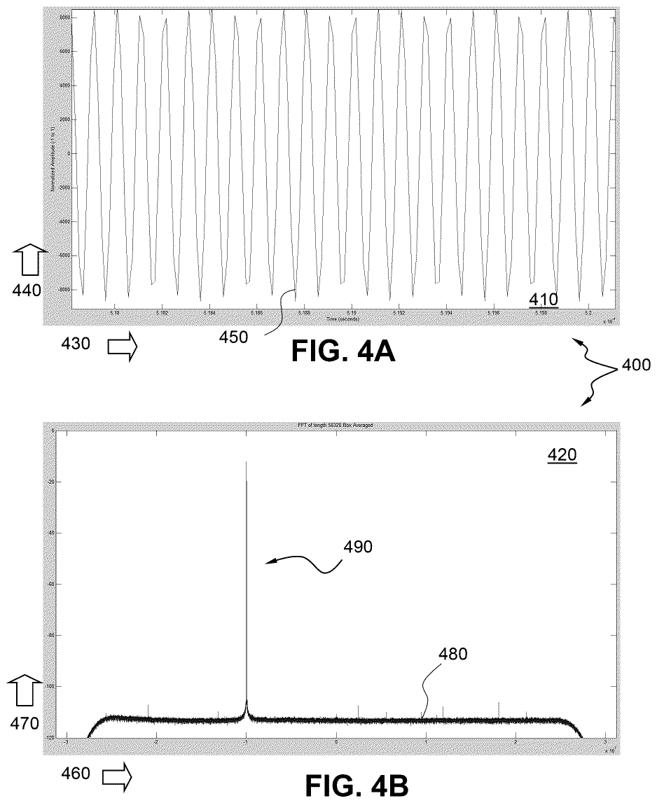

FIGS. 4A and 4B shows graphical views 400 for an analog signal. FIG. 4A features a first plot 410 of time versus magnitude, while FIG. 4B features a second plot 420 of frequency versus spectrum. For the first plot 410, time 430 (mili-seconds) denotes the abscissa and normalized amplitude 440 (across ±1) features the ordinate, with the oscillating analog signal 450 showing the transient magnitude response. Interval for time 430 ranges from 0.5179 ms to 0.5201 ms. For the second plot 420, frequency 460 (times 10 MHz) denotes the abscissa and spectrum (decibels) 470 denotes the ordinate, with the signal 480 featuring a spike 490 at minus one, corresponding to −10 MHz. Information from the oscillatory signal 450 can thereby be compressed into a single value based on the spike signal 490.

Once the process is established and algorithms modified to optimize amplitude detection, the same approach can be performed using hardware with sufficient specifications to perform in real-time. It is likely in the event the hardware cannot perform the DSP operations in real-time that a software implementation applied on the recoded CDIF file may be sufficient. In conventional implementation, analog-to-digital conversion (ADC) data are packetized with the proper time stamp information in VITA-49 payloads comprising 8160 discrete samples. They are than converted to complex data (in-phase & quadrature) and packed into 4080 samples consisting of complex data as shown in view 200.

This packetized group of 4080 complex samples is than inserted into a single datagram that includes channel identification (ID) #and integer time stamp from the FPGA. This datagram is written to the recording device hard drive. This stream of data continues until the recording terminates, becoming the time stamped CDIF data. During signal archive, the complex samples are reordered in a manner so that a Platinum/Blue header can be attached and populated with CDIF file parameters.

In the exemplary implementation, an additional thread is created and a duplicate stream of datagrams routes to a FIFO buffer resident on the FPGA/ASIC. At that point, algorithms are performed to generate Frequency Spectrum, Absolute Magnitude, and Time Domain information of the complex samples embedded similar to views 200, 300 and 400.

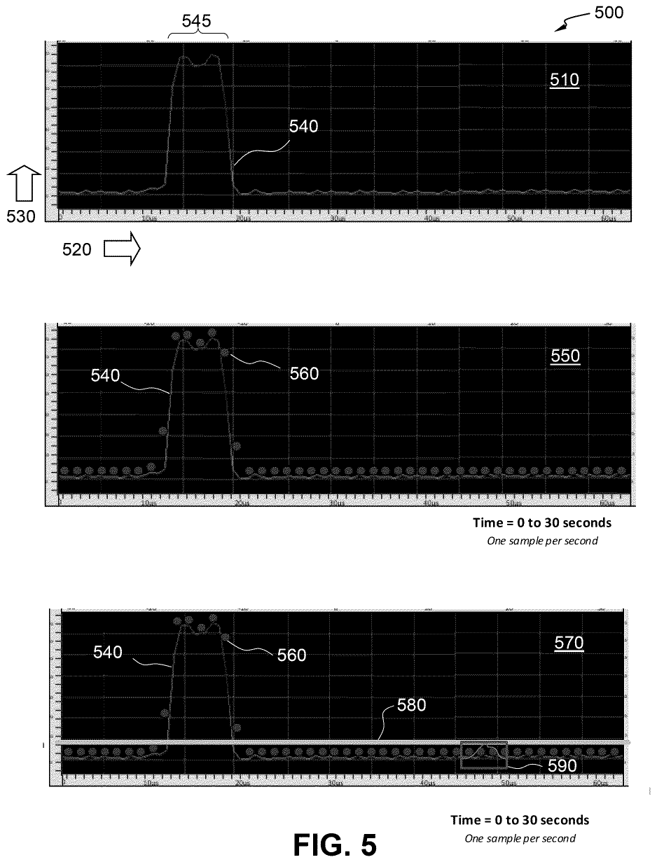

FIG. 5 shows graphical views 500 of a temporal signal digitized into event data. A first graph 510 shows real-time analog event data for time from zero to thirty seconds. Time 520 (microseconds) denotes the abscissa and magnitude 530 (unscaled) features the ordinate. An analog signal trace 540 indicates an event 545 from its magnitude increase between 13 μs and 18 μs. A second graph 550 shows the analog data transformed to digital samples.

The signal trace 540 is acquired at one sample per second from zero to thirty seconds as discrete samples 560. A third graph 570 shows results from an amplitude detection algorithm for event identification. The exemplary algorithm determines an event detection threshold (EDT) 580 from which to compare the samples 560. The event 545 clears this threshold 580 unambiguously. A fluctuation window 590 reveals a signal perturbation near the EDT 580. Samples 560 below the EDT 580 are discarded, except those within the window 590. The EDT 580 may be related to the NRT.

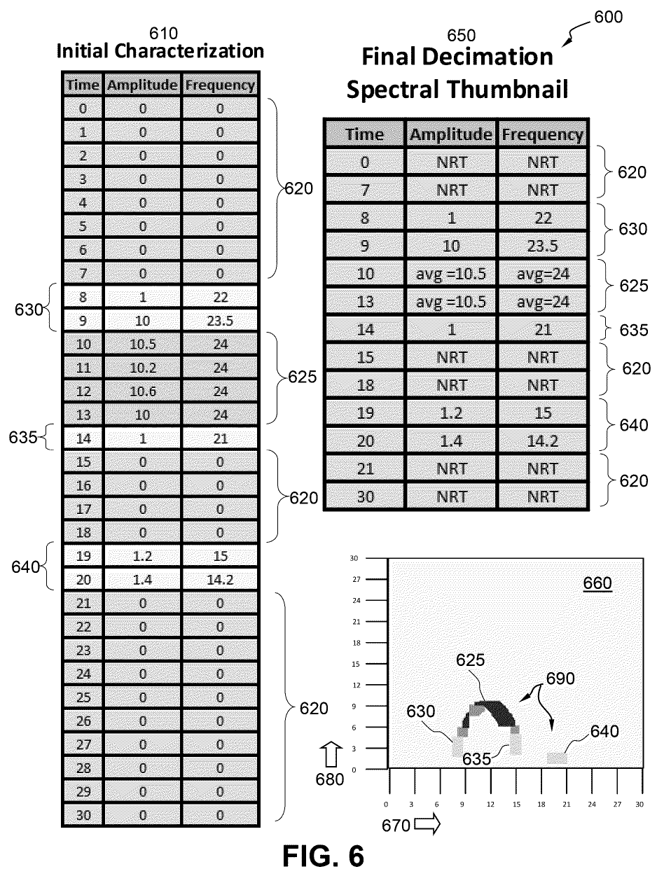

FIG. 6 shows array views 600 of data tables with parameter characterization and thumbnail representation based on samples 560. A first array 610 for initial characterization tabulates corresponding values for time, amplitude and frequency. Repeats of identical values in the first array 610 can be grouped as either trivial sets 620 or steady non-zero interval 625, with non-repeating transient values 630, 635 and 640 interspersed therebetween. The parameters are correlated with a second thumbnail array 650 that provides final decimation for a spectral thumbnail based on time, amplitude and frequency. The thumbnail array 650 collapses the sets 620 and 625 to their start and terminus, with trivial values denoted as NRT. This example reduces thirty-one rows in the first array 610 to thirteen rows in the second array 650, thereby removing extraneously repeated NRT-valued values of amplitude and frequency as unnecessary for further processing.

A graphical plot 660 illustrates these values by time 670 as the abscissa and magnitude 680 as the ordinate with plotted values 690 from the array 650. The values 690 correspond to the sets 625, 630, 635 and 640. Plot 570 correlates with thumbnail array 650 as follows. Analog signal event 545 corresponds to non-zero interval 625 between 10 s and 13 s at amplitude of about ten, while fluctuation window 595 corresponds to the transient set 640 between 19 s and 20 s at an amplitude slightly above unity.

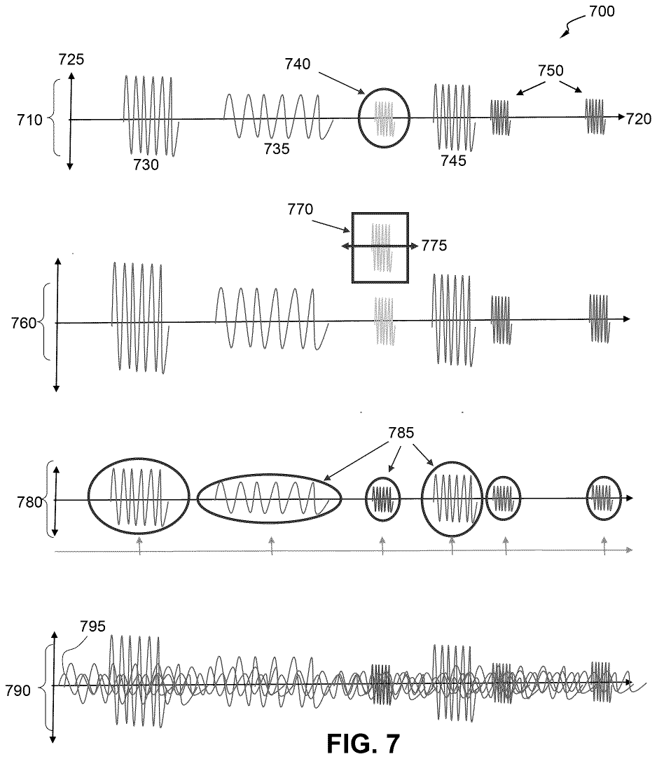

FIG. 7 shows analog signal waveform views 700 of different interspaced frequencies and amplitudes. A first waveform 710 with time 720 as the abscissa and amplitude as the ordinate 725 illustrates discrete interspaced pulses 730, 735, 740, 745 and 750. The encircled pulse 740 can be converted to a carrier wave. A second waveform 760 shows the pulse 740 replicated as highlighted pulse 770 and its wavelength stretched 775. A third waveform 780 encircles all the discrete pulses 785 and overlays them in a fourth waveform 790 with a carrier wave 795 based on the copied and stretched pulse 770. These signals combine by superposition.

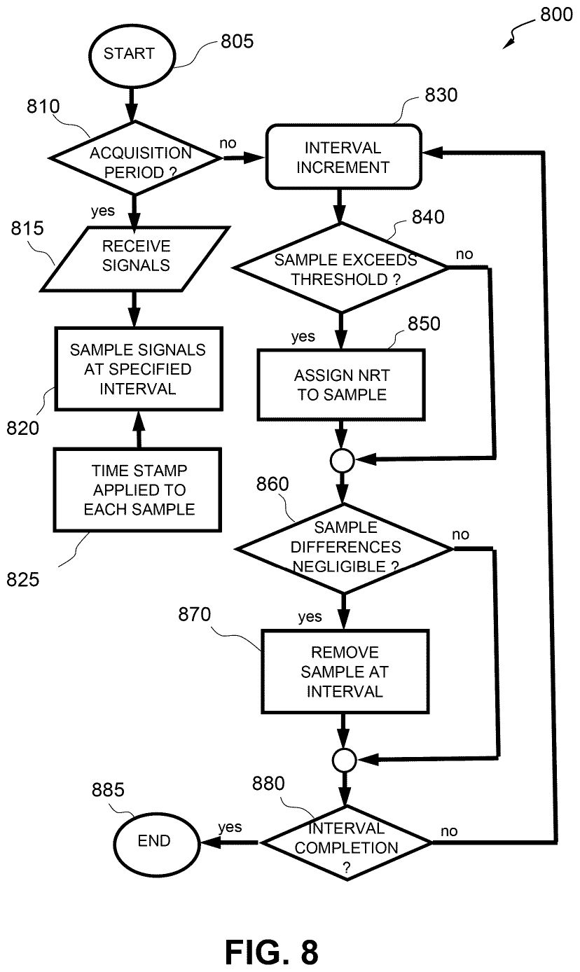

FIG. 8 shows a flowchart view 800 of exemplary operations to conduct the exemplary data reformat process and corresponding signal analysis for sample selection. The process begins 805 by a first query 810 determining whether operation corresponds to an acquisition period and if so reading the signal data 815. Select parameters of the signals (e.g., amplitude) are digitally sampled 820 at a specified interval, with each sample assigned a time stamp 825. Parameter values are thus periodically obtained at corresponding time-stamped intervals over the acquisition period and accumulated as a digital stack. Otherwise upon completing the acquisition period, the operation establishes an interval sequence 830.

Then a second query 840 determines whether the parameter value exceeds a threshold. If not, the value is assigned NRT 850, all of which are treated as identical for comparison purposes. Otherwise, the process continues to a third query 860 comparing the parameter value at the present interval for sequence 830 against those values from the previous and subsequent intervals. If the difference between all these values is negligible within some tolerance, the process removes 870 the value at the present interval from the stack. Otherwise, the process proceeds to a fourth query 880 to determine whether the sequence has completed. If so, the process terminates 835, with recording of the stack. Otherwise, the process returns to the increment 830 for the next interval.

A feature extraction algorithm can be used to abstract the data and perform an interpolation to minimize data points required for proper characterization, as shown from initial array 610 to truncated array 650. An additional feature extraction occurs during this process and is saved in a separate annotation file providing event information. A copy of the time stamp applied to the characterized datagram 310, 320 can then be appended to the file before transfer to the record drive. This permits a full description of each individual datagram that collectively produces the CDIF recording. The manner in which the information is indexed enables operators and analysts to perform extraction of real sampled data using time, magnitude, and bandwidth (or any combination) of features contained in the CDIF file. The objective is to provide tools that mimic processes that exist in conventional signal analysis software.

The size of the index file is therefore significantly smaller than the linked CDIF characterized. The write speed of the CDIF recorded on disk or other memory remains at a constant rate regardless of analog data being transformed. The write speed of the index file varies with the features contained collectively in the datagrams of the recording.

Due to the periodic nature of signals expected to be recorded (transient) and significant reduction in points required for characterization outside of illumination times—FIFO memory should be sufficient to maintain the process during the entire CDIF recording. However, in the event FIFO memory and CPU processing time required is approaching limits—frequency & magnitude resolution along with threshold amplitude is reduced temporarily. Note that view 130 lists index file sizes in relation to bandwidth 140 and data rate 150.

This shifts the paradigm when initial verification and screening occurs in CDIF recordings on the platform and analysis sites. When selecting the file desired for analysis, the option can be given to use the index file in the analytic tool required. Currently, depending on the tool used the percentage of the entire CDIF file required to open may range from 100% to a smaller percentage associated with time. The reduction in data size of the index file relative to the CDIF file should be on the order of greater than 98%. This translates to the difference in loading a file size of 900 GB versus 828 MB.

Upon opening the index file, the analyst will than have the capability to manipulate data accordingly and identify areas in the CDIF required for inspection. The analyst is also provided the capability to re-index the data observed by manipulation of amplitude thresholds and/or frequency desired to observe. The capability to extract band-limited data relative to the signal bandwidth required to process is achieved by using an exemplary algorithm in the software to further decimate samples in the full CDIF recording. Upon identifying the highlighted sections, the required complex samples are extracted from the CDIF file enabling additional analysis desired.

The cost and time savings this solution provides can be distributed across the entire pyramid of activities involved with tasking to meet collection objectives. Starting at the in-service engineering agent (ISEA), initial testing and verification of signal record fidelity is verified. With the increasing bandwidths and the additional complexity of testing performed—the amount of time and personnel required to ensure faithful reproduction of SOI parameters increases. During collection, the added difficulty verifying that basic signal parameters were captured in recordings ads significant man-hours allotted to perform this function. Some of the difficulties encountered by the analysis labs to perform reporting of SOI's contained in these large CDIF recordings was previously detailed.

This solution will provide substantial savings across all these entities by streamlining the processes required at each level. Once the solution is applied, all future recorders or devices that capture large bandwidths creating large CDIF files can be required to meet this objective during design specifications. The solution is not hardware-specific and is the only viable method to manage the increasing bandwidth requirement being levied today and is expected to increase in the future. The short-term costs and coordination across multiple commands are extremely minor relative to the alternatives.

Challenges include developing an algorithm that provides the appropriate EDT 580 to ensure 100% of event capture above a specified level, while minimizing false detections. Also, algorithms to perform event detection and spectrum characterization either within or in close proximity of capture device (camera, receiver, etc.) to increase efficiencies. Any processing constraints of the event capture hardware used to perform the detection and buffer the data should be analyzed and may potentially limit the efficient application of the algorithm on some platforms.

Solutions: The exemplary implementation characterizes the data recording into what one can label a “spectral thumbnail”, which can be produced in parallel with the standard data recording. This thumbnail will be significantly smaller than the data recording and will have a variable rate based on event duty cycle. One can estimate the spectrum thumbnail file size relative to the data file to average one-to-two percent of original (dependent on duty cycle). The algorithm is performed on the data recording to detect all event data (transient or continuous) above the NRT 840. As a further compression operation, the algorithm can remove repetitious event data 870 to reduce redundancy. The information derived by application of this algorithm can then be stored in a separate file that is associated and dynamically linked with the data recording. This enables real-time analysis, or efficient review of the recorded data by using the spectrum thumbnail file.

In order to facilitate the screening and processing of large bandwidth data recordings, Combat Direction Systems Activity Dam Neck (CDSADN) desires a process that maps a CDIF recording (Time, Magnitude, and Frequency) to a spectrogram, referred to here as a Spectral Thumbnail. This Spectral Thumbnail is produced in parallel to a standard CDIF recording.

The algorithm is performed on the CDIF recording to detect all energy (transient or continuous) above an NRT. Results of applying this algorithm include storing time, magnitude, and bandwidth information in a separate file associated and dynamically linked with the CDIF recording. The thumbnail is significantly smaller than the original recording and has a variable rate based on the duty cycle of the SOI. The original CDIF recording is retained for separate analysis.

This solution is implemented by utilizing Innovative Integration, the manufacturer of key hardware/firmware portions of a government developed digital recorder. Once a satisfactory algorithm has been developed, the solution simulated in MATLAB, revised software and MATLAB simulation are to be delivered.

Future development will involve the following:

(1) Creation of a MATLAB model will be needed that accurately simulates the performance of the Spectrogram upon implementation on the CDSADN developed digital recorder using key Innovative Integration hardware/firmware portions of the associated assemblies. The model can be built to achieve optimal results achievable with regards to indexing (Time, Magnitude, and Frequency) of CDIF data. The model will be scalable in a manner that enables maximum results possible from optimal hardware requirements to any system specific hardware constraints/limitations. The model achieves on average a greater than 95% reduction in size relative to CDIF data indexed.

(2) The Spectral Thumbnail produced should enable additional time increment(s) selectivity, adjustable magnitude threshold detection, and bandwidth reduction achieved through sample decimation.

(3) All software code should include MATLAB source code and SIMULINK models will be provided upon completion of a satisfactory MATLAB simulation of the Spectral Thumbnail implementation. This will include any additional software required to produce simulated/real input data arrays.

(4) The customer (GDIT/CDSADN) will provide any requested unclassified sample data to Innovative Integration required during the development process and will work concurrently with the Innovative Integration engineering team with developing a satisfactory product. This will include (if determined) on-site support required during this process, phone, and email.

Innovative Integration will provide incremental delivery during development, based on an agreed-to level of completion, for testing by the customer in order to ensure development is proceeding as planned to meet the end goal. One expects to deliver Innovative integration of the completed TL Spectrum MATLAB model, source code, associated firmware upgrade, Spectrum MATLAB model documentation and firmware documentation.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A computer-implemented method for compressing a signal, said method comprising:
acquiring the signal;
sampling a plurality of values from the signal;
assigning to an event said each value that exceeds an event threshold; and
removing said each value from said plurality in response to equivalence within a tolerance to previous and subsequent adjacent values.

2. The method according to claim 1, wherein including:
assigning said each value excluded from said event as a noise riding threshold (NRT).

3. The method according to claim 2, wherein said tolerance exceeds said NRT.

4. The method according to claim 1, wherein said assigning and removing operations are performed within an incremental period that corresponds to said sampling operation.

5. The method according to claim 1, wherein said sampling operation further includes associating said each value with a time stamp.

6. The method according to claim 5, wherein said each value is separated from an adjacent value by an interval gap.

7. The method according to claim 1, further including displaying said plurality in a datagram.
